(19) United States
(12) Patent Application Publication
(10) Pub. No.: US 2025/0133359 A1
(43) Pub. Date: Apr. 24, 2025

(54) DIAPHRAGM MANUFACTURING METHOD

(71) Applicant: DRAGONSTATE TECHNOLOGY CO., LTD., New Taipei City (TW)

(72) Inventor: Lei CHENG, Kunshan City (CN)

(21) Appl. No.: 18/413,940

(22) Filed: Jan. 16, 2024

(30) Foreign Application Priority Data
Oct. 20, 2023 (TW) 112140109

(51) Int. Cl. H04R 31/00

(52) U.S. Cl. CPC H04R 31/003; H04R 2231/001

(57) ABSTRACT

The present invention provides a diaphragm manufacturing method, including: a base, a membrane, a molding step, and a cutting preparation step. The membrane is fitted at a central location of a through hole and forms an interspace a main body portion. A molding step further consists of forming a suspending edge between the main body portion and the membrane, whereby the suspending edge is formed with extended portions that extend into corresponding connecting grooves. A cutting step comprises cutting the connecting portions and the extended portions, to form a diaphragm fabricated from the main body portion, the membrane, and the suspending edge. The base can be gripped by mechanical arms by means of the external portions, thus achieving the effectiveness of automated production, as well as increasing production yield and efficiency.

### BACKGROUND OF THE INVENTION

### (a) Field of the Invention

The present invention relates to a diaphragm, and more particularly to a diaphragm manufacturing method that is able to increase production yield and efficiency.

### (b) Description of the Prior Art

A diaphragm is mainly used in speakers to generate sound through vibration, wherein the diaphragm comprises a membrane formed in the center thereof and spring arms formed on the periphery of the membrane, which are used to connect to a voice coil, which, together with a magnet, generates a magnetic action that enables the voice coil to drive the membrane together with an up and down vibrational amplitude effect produced by the spring arms, causing sound to be emitted.

During the molding process, the majority of current diaphragms can be divided into adhesive types and injection molded types, wherein adhesive type diaphragms mainly use an adhesion method to assemble a membrane and spring arms, whereas the injection molded diaphragm adopts an injection molding method to form the spring arms on the membrane.

However, regardless of whether the diaphragm is formed using the above-described adhesive method or injection molded method, production cannot be usually automated after forming the diaphragm, which easily results in a decrease in yield during the production process, and thus a relatively poor production efficiency.

Accordingly, the problem to be solved by the present invention involves providing a diaphragm manufacturing method that is able to increase production efficiency and yield.

### SUMMARY OF THE INVENTION

The main object of the present invention lies in providing a diaphragm manufacturing method, and more particularly to a diaphragm manufacturing method that is able to improve production efficiency and yield through automated production.

In order to achieve the aforementioned object, the present invention provides a diaphragm manufacturing method, comprising: providing a base and a membrane, a molding step, and a cutting step. The base is assembled from a main body portion, an external portion, and connecting portions, wherein the center of the main body portion is provided with a through hole. The external portion is configured on the periphery of the main body portion, and is mutually joined thereto by means of connecting portions. Connecting grooves that afford passage to the through hole are formed on the external portion and the connecting portions. The membrane is fitted at a central location of the through hole, and is used to form an interspace in the main body portion. The molding step comprises molding a suspending edge between the main body portion and the membrane, wherein the suspending edge connects the main body portion and the membrane; moreover, the suspending edge is formed with extended portions that correspondingly extend into the respective connecting groove. The cutting step comprises a cutting operation carried out on the connecting areas between the main body portion and the connecting portions, concurrently cutting the connecting portions and the extended portions. Accordingly, the diaphragm is formed from the main body portion, the membrane, and the suspending edge.

In an embodiment of the present invention, the suspending edge further comprises a first joining portion that connects to the membrane, a second joining portion that connects to the main body portion, and an elastic portion positioned between the first joining portion and the second joining portion. Moreover, the elastic portion is positioned in the interspace.

In the embodiment of the present invention, the extended portions are formed to extend from the second joining portion into the corresponding connecting groove.

In the embodiment of the present invention, the suspending edge is formed by injection molding using silica gel material.

In the embodiment of the present invention, the base is formed as an integral body using plastic material.

In the embodiment of the present invention, the membrane is formed from either plastic or metallic material.

In the embodiment of the present invention, after forming the diaphragm, first cut-out sections are formed on the side of the main body portion located at the positions corresponding to the connecting portions.

In the embodiment of the present invention, after forming the diaphragm, second cut-out sections are formed on the side of the suspending edge located at the positions corresponding to the extended portions.

In the embodiment of the present invention, a plurality of protruding portions are formed on the external portion.

In the embodiment of the present invention, a plurality of positioning holes are formed on the external portion.

The present invention is provided with the following advantages compared to the prior art: through the configuration of the base, the present invention enables automated production machines and tools, such as mechanical arms, to carry out operating procedures thereon, which further enables improving production automation, thereby substantially increasing production yield and efficiency.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

FIG. 1 is a three-dimensional exploded view of the present invention.

FIG. 2 is a cross-sectional view of a base of the present invention.

FIG. 3 is a cross-sectional view of a mold of the present invention.

FIG. 4 is a three-dimensional view of the present invention after an injection molding step.

FIG. 5 is a cross-sectional view of FIG. 4.

FIG. 6 is a three-dimensional view of a diaphragm of the present invention.

FIG. 7 is a cross-sectional view of FIG. 6.

### DETAILED DESCRIPTION OF THE PREFERRED EMBODIMENTS

In order for the review committee to further understand the technology, means, and effectiveness adopted to achieve the intended objects of the present invention, examples of the preferred and feasible embodiments, together with the accompanying drawings are described in detail below, which will enable gaining an in-depth understanding of the objects, characteristics, and advantages of the present invention.

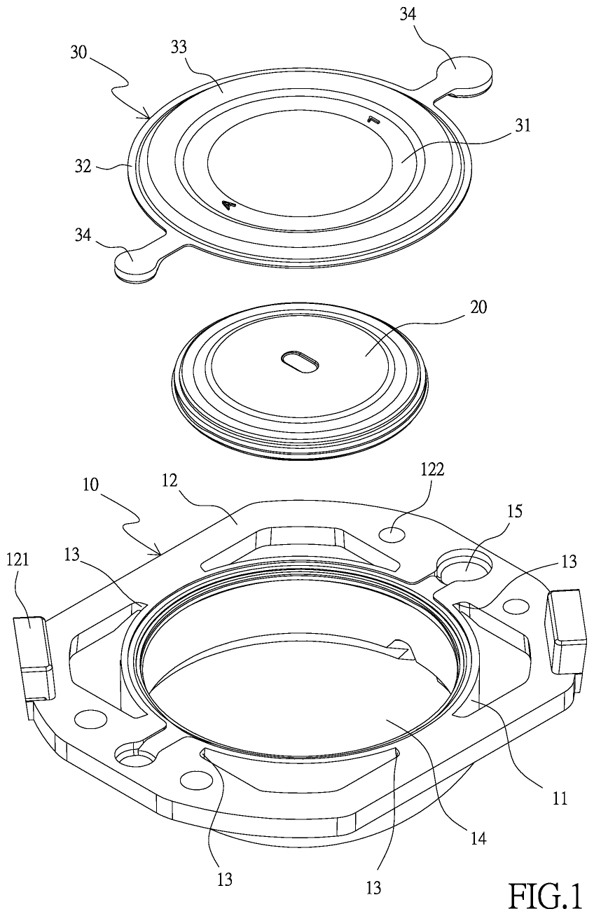

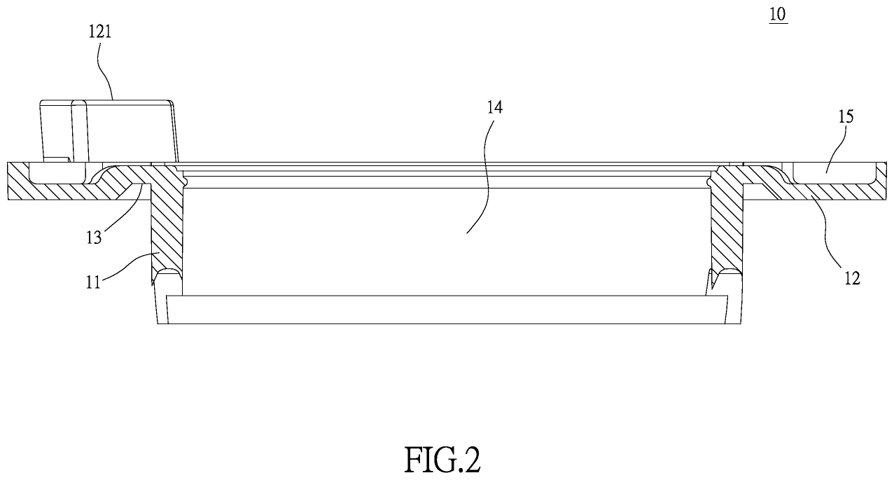

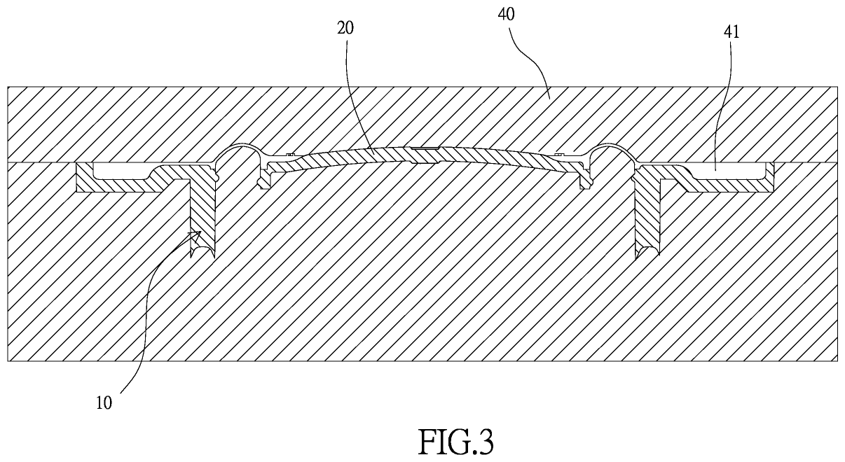

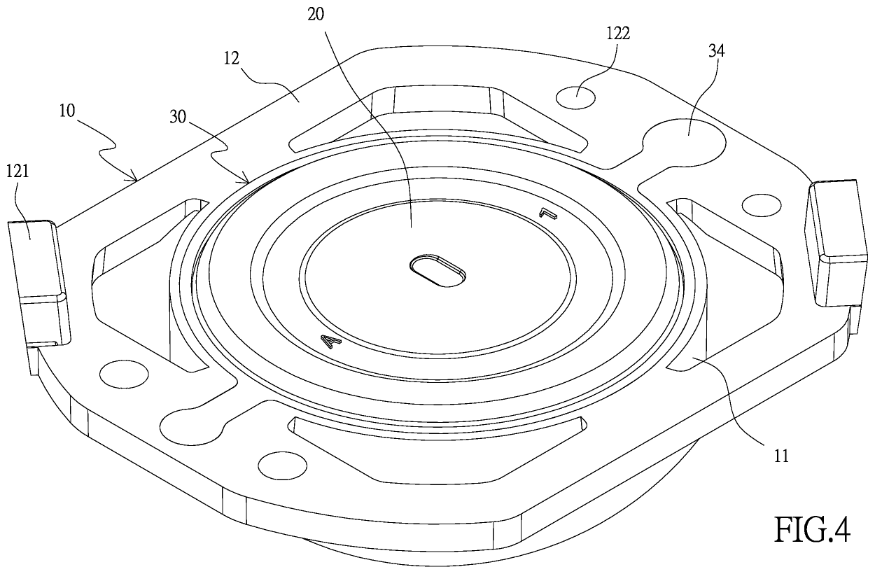

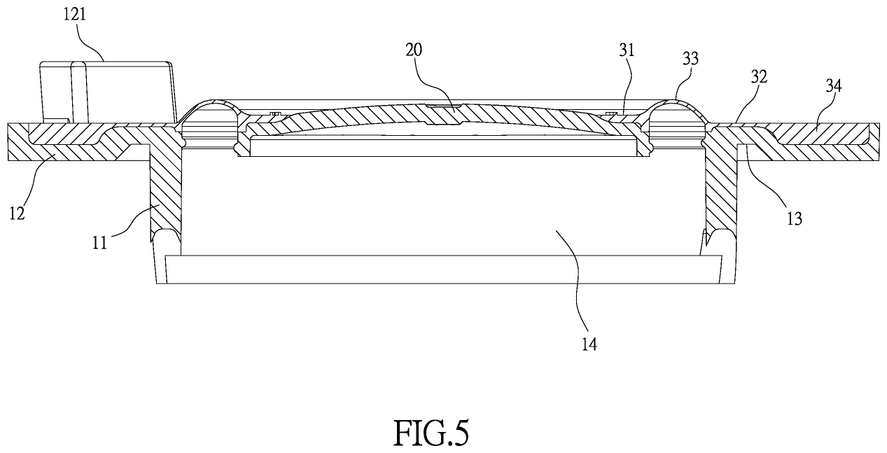

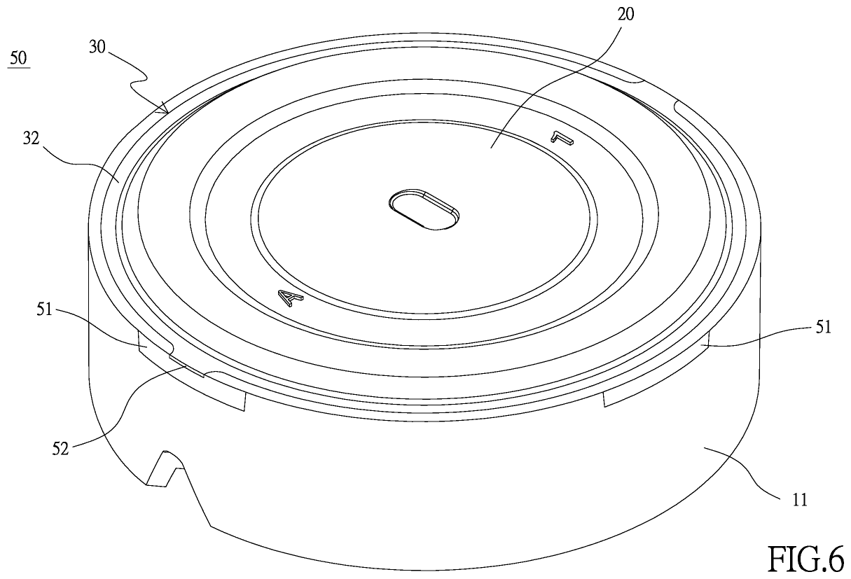

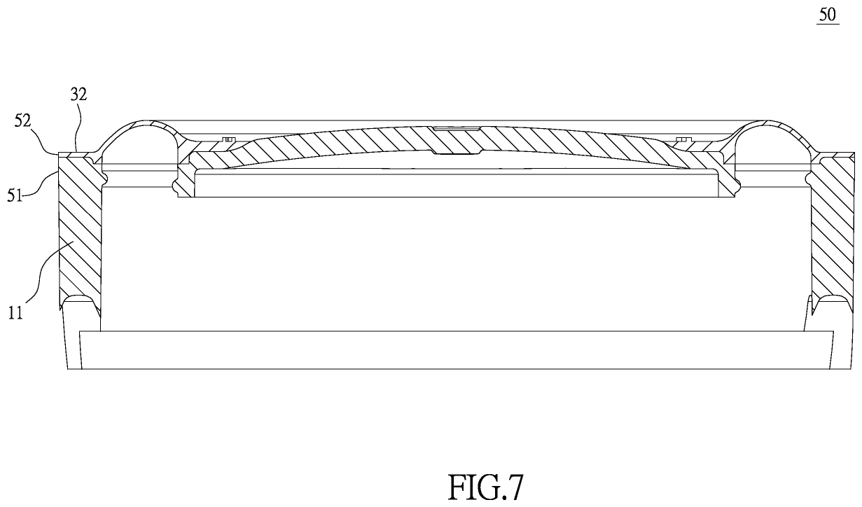

Referring to FIGS. 1 to 7, the present invention provides a diaphragm manufacturing method, wherein a diaphragm produced from the manufacturing method mainly has application in speakers. The manufacturing method comprises: providing a base 10; providing a membrane 20; a molding step used to form a suspending edge 30; and a cutting preparation step.

First, the base 10 adopts an injection molding method to form an integral body using plastic material, wherein the base 10 is fabricated from a main body portion 11, an external portion 12, and at least one connecting portion 13. The center of the main body portion 11 is provided with a through hole 14; the external portion 12 is configured on the periphery of the main body portion 11; and the connecting portion(s) 13 is/are used to connect the main body portion 11 and the external portion 12. Connecting grooves 15, which afford passage to the through hole 14, are additionally formed on the external portion 12 and the connecting portions 13. In the present embodiment, the main body portion 11 assumes a ring shape, and four connecting portions 13 are configured between the main body portion 11 and the external portion 12, wherein the connecting portions 13 are equidistant distributed between the main body portion 11 and the external portion 12. Two of the connecting portions 13 are respectively provided with the connecting groove 15 that affords passage to the through hole 14.

The membrane 20 can be produced from plastic material or from metallic material, and in the present embodiment plastic material molding is used to form the membrane 20.

The molding step mainly comprises sequentially placing the base 10 and the membrane 20 inside a mold 40 (a method that belongs to prior art, and thus not further detailed herein); positioning the membrane 20 in the central location of the through hole 14 to form an interspace between the membrane 20 and the main body portion 11; and forming a molding space 41 inside the mold 40. An injection molding method is then used to inject silica gel material inside the molding space 41. After the silica gel material has cooled and solidified, the suspending edge 30 is formed inside the molding space 41, whereby the suspending edge 30 comprises a first joining portion 31 that connects to the membrane 20, a second joining portion 32 that connects to the main body portion 11, an elastic portion 33 positioned between the first joining portion 31 and the second joining portion 32, and at least one extended portion 34 that extends from the second joining portion 32 to the connecting groove 15. The elastic portion 33 is positioned in the interspace. In the present embodiment because two of the connecting grooves 15 are provided on the base 10, thus, two of the extended portions 34 are concurrently configured on the suspending edges 30, wherein each of the extended portions 34 correspond to the respective formed connecting groove 15.

In the cutting preparation step, after the suspending edge 30 is formed between the base 10 and the membrane 20, the base 10 is extracted from the mold 40, and a cutting operation is carried out at the connecting area between the main body portion 11 and the connecting portions 13, which concurrently cuts each of the connecting portions 13 and each of the extended portions 34, whereafter the main body portion 11, the membrane 20, and the suspending edge 30 form a diaphragm 50.

It is worth mentioning that because the diaphragm 50 in the present embodiment is formed after the cutting operation on the base 10, thus, the outer side of the main body portion 11 is formed with first cut-out sections 51 from after cutting each of the connecting portions 13. Furthermore, the outer side of each the second joining portions 32 is formed with a second cut-out section 52 from after cutting each of the extended portions 34, thereby enabling increasing recognition of the diaphragm 50.

In addition, in the present embodiment, in order to improve the effectiveness of automated production, the external portion 12 of the base 10 is further mainly configured with a plurality of protruding portions 121 that protrude from the surface of the external portion 12. Moreover, the external portion 12 is additionally provided with a plurality of positioning holes 122 that penetrate the external portion 12. Accordingly, when the base 10 is being placed inside the mold 40, the plurality of protruding portions 121 enable a mechanical arm to grip the base 10 (a method that belongs to prior art, and thus not further detailed herein). Further, the positioning holes 122 can be used to effectively fix the base 10 within the mold 40. And after forming the suspending edge 30, the protruding portions 121 can be used by a mechanical arm to grip the base 10, enabling the base 10 to be extracted from the mold 40, thereby achieving the effectiveness of fully automated production and effectively improving production efficiency and yield.

It is also worth mentioning that because the diaphragm 50 manufactured through the present invention mainly has application in speakers, thus, the size of the diaphragm is quite small, and after the base 10 is formed with the external portion 12 on the periphery of the main body portion 11, there is no need for a mechanical arm to directly grip the main body portion 11, and only needs to grip the protruding portions 121 on the external portion 12, thereby preventing the mechanical arm from damaging the diaphragm 50, further effectively and substantially increasing production yield.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A diaphragm manufacturing method, comprising steps of:
a) providing a base, the base is assembled from a main body portion, an external portion, and connecting portions, wherein the center of the main body portion is provided with a through hole; the external portion is configured on the periphery of the main body portion, and is mutually joined thereto by means of connecting portions; connecting grooves that afford passage to the through hole are formed on the external portion and the connecting portions;
b) providing a membrane, the membrane is fitted at a central location of the through hole, and forms an interspace in the main body portion;
c) providing a molding step, the molding step comprises molding a suspending edge between the main body portion and the membrane, the suspending edge connects the main body portion and the membrane, and the suspending edge is formed with extended portions that correspondingly extend into the respective connecting groove; and
d) providing a cutting step, the cutting step comprises a cutting operation carried out on the connecting areas between the main body portion and the connecting portions, concurrently cutting the connecting portions and the extended portions; the diaphragm is thereby formed from the main body portion, the membrane, and the suspending edge.

2. The diaphragm manufacturing method according to claim 1, wherein the suspending edge further comprises a first joining portion that connects to the membrane, a second joining portion that connects to the main body portion, and an elastic portion positioned between the first joining portion and the second joining portion; moreover, the elastic portion is positioned in the interspace.

3. The diaphragm manufacturing method according to claim 2, wherein the extended portions are formed to extend from the second joining portion into the corresponding connecting groove.

4. The diaphragm manufacturing method according to claim 2, wherein the suspending edge is formed by injection molding using silica gel material.

5. The diaphragm manufacturing method according to claim 1, wherein the base is formed as an integral body using plastic material.

6. The diaphragm manufacturing method according to claim 1, wherein the membrane is formed from either plastic or metallic material.

7. The diaphragm manufacturing method according to claim 1, wherein, after forming the diaphragm, first cut-out sections are formed on the side of the main body portion located at the positions corresponding to the connecting portions.

8. The diaphragm manufacturing method according to claim 1, wherein after forming the diaphragm, second cut-out sections are formed on the side of the suspending edge located at the positions corresponding to the extended portions.

9. The diaphragm manufacturing method according to claim 1, wherein a plurality of protruding portions are formed on the external portion.

10. The diaphragm manufacturing method according to claim 1, wherein a plurality of positioning holes are formed on the external portion.
